(19) United States
(12) Patent Application Publication
(10) Pub. No.: US 2019/0210320 A1
(43) Pub. Date: Jul. 11, 2019

(54) FIBER-COMPOSITE SANDWICH MATERIAL CONTAINING SHAPE-MEMORY ALLOYS

(71) Applicant: AIRBUS OPERATIONS GMBH, Hamburg (DE)

(72) Inventors: Marc FETTE, Hamburg (DE); Martin HENTSCHEL, Stade (DE)

(21) Appl. No.: 16/234,784

(22) Filed: Dec. 28, 2018

(30) Foreign Application Priority Data
Dec. 29, 2017 (DE) 20 2017 107 958.9

(51) Int. Cl. B32B 5/02; B32B 27/12; B32B 25/08; B32B 25/10; B29C 70/34

(52) U.S. Cl. CPC B32B 5/024; B32B 27/12; B32B 25/08; B29K 2305/00; B29C 70/345; B32B 2262/103; B32B 2605/18; B32B 25/10

(57) ABSTRACT

A sandwich component including at least two cover layers and one core layer containing wires including shape-memory metal. A process for producing the sandwich component is also disclosed.

### CROSS-REFERENCE TO RELATED APPLICATION

This application claims priority to German Patent Application No. 20 2017 107 958.9 filed Dec. 29, 2017, the entire disclosure of which is incorporated by reference herein.

### TECHNICAL FIELD

The disclosure herein relates to a sandwich component composed of or comprising at least two cover layers and one core layer containing wires composed of or comprising shape-memory metal.

### BACKGROUND

When producing fiber-composite materials, a plurality of plies of fiber material can be layered on top of one another and subsequently cured, this also being referred to as consolidation. The curing is made possible by a matrix material. It can be a reactive resin (thermoset) or a non-reactive meltable plastic is used (thermoplast). Either the matrix material is already situated on the fibers (so-called prepregs) or the matrix material is injected into the fiber material. The non-cured or not yet completely cured material is referred to as semi-finished product.

Another way of producing fiber-composite materials is to cure a mixture of matrix material and long fibers as press compound in a mold under pressure and temperature. Such long-fiber-reinforced press compounds with thermoset matrix comprise long fibers having an average fiber length within the range between 10 mm and 79 mm, preferably within the range between 25 mm and 50 mm. The long fibers are carbon or glass fibers which are embedded as random fibers, i.e. quasi-isotropically, into a matrix based on thermoset reaction resins, such as, for example, unsaturated polyester, vinyl ester, epoxide or polyaryl ether amide resins. They are referred to as sheet molding compound (SMC) or bulk molding compound (BMC). BMCs differ from SMCs in that they also have a substantial extent in the thickness direction.

Sandwich components are understood to mean fiber-composite components which are constructed in a multi-layer manner and comprise at least one core layer between cover layers. The core layer can be wood, foam, a honeycomb core. As a result, it is possible to produce comparatively light components, the mechanical properties of which are not reached by a component composed of solid fiber-composite material of identical weight.

Shape-memory alloys (SMAs) are special metals which can exist in two different crystal structures. They are often also referred to as memory metals. This comes from the phenomenon that they can seemingly “remember” an earlier shape despite subsequent strong deformation. Whereas the majority of metals always have the same crystal structure up to their melting point, shape-memory alloys have, depending on the temperature, two different structures or phases. The shape transformation is thus based on the temperature-dependent lattice transformation to form one of these two crystal structures. There is generally a high-temperature phase called austenite and a low-temperature phase (martensite). Both can transition into one another in a reversible manner as a result of temperature change, this being referred to as the two-way effect.

The structure transformation can be caused by a change in temperature.

In vehicle and aircraft construction, not only are very many rigid or stiff components used, but also those components which allow a specific change in shape. Examples thereof are seating or reclining surfaces as well as fluid-dynamic control elements such as rudders, sails or conveying channels. In most cases, such components which change their shape comprise a flexible element, be it through articulated connection of multiple sub-surfaces or a reversibly deformable surface element, for example composed of cloth or a thin panel-shaped sheeting or sheet and also a positioning apparatus, which is used to achieve a change in shape of the component.

Proceeding from all that, it is therefore an object of the disclosure herein to provide improved adjustable planar components which allow simple control.

### SUMMARY

It has now been found that, completely surprisingly to a person skilled in the art, the disadvantages of the prior art are remedied by a sandwich component (1′) comprising at least two cover layers (3′, 5′) and one core layer (7′) containing wires (24) composed of or comprising shape-memory metal.

It is preferred when the sandwich component (1′) is obtainable by a process having the following steps:

(a) providing a press device (11) having a first mold part (13) and a second mold part (15) which can be moved relative to one another between a closed position (17), in which they enclose a cavity (9), and an open position (19), in which the cavity (9) is open to the environment, wherein the first mold part (13) and/or the second mold part (15) are heatable;

(b) providing a semi-finished sandwich product (1) having a first cover-layer semi-finished ply (3) composed of or comprising a long-fiber-reinforced press compound with thermoset matrix, a second cover-layer semi-finished ply (5) composed of or comprising a long-fiber-reinforced press compound with thermoset matrix and, between them, a core-layer semi-finished ply (7);

(c) in the open position (19) of the press device (11), inserting the semi-finished sandwich product (1) into the cavity (9);

(d) moving the first and the second mold part (13, 15) relative to one another into the closed position (17);

(e) pressing together the first and the second mold part (13, 15), with the result that the semi-finished sandwich product (1) experiences a certain press pressure, and heating the first and/or the second mold part (13, 15), with the result that the semi-finished sandwich product (1) experiences a certain processing temperature, wherein the press device (11) comprises a spacer (21), which, in the closed position (17), defines the minimum distance between the first and the second mold part (13, 15) and thus sets the minimum dimensions of the cavity (9), and wherein the spacer (21) is adjusted such that the press pressure in the closed position (17) is between a minimum processing pressure of the first and/or the second cover-layer semi-finished ply (3, 5) and a maximum permissible pressure limit for the core-layer semi-finished ply (7). It is further preferred that the wires (24) composed of or comprising shape-memory metal in the core layer (7′) are arranged substantially in parallel to one another. It is further preferred when the wires (24) composed of or comprising shape-memory metal in the core layer (7′) are arranged in relation to one another substantially in the form of a woven fabric. It is further preferred that the wires (24) composed of or comprising shape-memory metal in the core layer (7′) are heatable. It is further preferred that the matrix of the cover layers consists of or comprises epoxy, vinyl ester, phenol or unsaturated polyester resin. It is further preferred that the intermediate layer (7) consists of or comprises an elastomer. It is further preferred when the intermediate layer (7) consists of or comprises EPDM, BR and/or EVA. It is further preferred that the intermediate layer (7) consists of or comprises EPDM, BR and EVA. It is further preferred that the intermediate layer (7) consists of or comprises elastomer in the form of calendered films. It is further preferred that the intermediate layer (7) consists of or comprises elastomer in the form of a plurality of calendered films, between which the wires (24) composed of or comprising shape-memory metal are arranged. It is further preferred that the wires (24) composed of or comprising shape-memory metal are electrically heatable. It is further preferred that the wires (24) composed of or comprising shape-memory metal are electrically heatable, by it being possible to apply an electric voltage to the wires themselves. It is further preferred that the wires (24) composed of or comprising shape-memory metal are heatable by induction. It is further preferred that the wires (24) composed of or comprising shape-memory metal can be temperature-adjusted by a cooling device. The disclosure herein also encompasses a wing tip of an aircraft that comprises a sandwich component according to the disclosure herein. The disclosure herein also encompasses an aileron, elevator or rudder of an aircraft that comprises a sandwich component according to the disclosure herein. The disclosure herein also encompasses an air channel for an aircraft that comprises a sandwich component according to the disclosure herein. The disclosure herein also encompasses a seat, recliner or bed for an aircraft that comprises a sandwich component according to the disclosure herein. The disclosure herein also encompasses a wing of an aircraft that comprises a sandwich component according to the disclosure herein. The disclosure herein also encompasses an air flap or ventilation nozzle of an aircraft that comprises a sandwich component according to the disclosure herein. The disclosure herein also encompasses a horizontal stabilizer or vertical stabilizer of an aircraft that comprises a sandwich component according to the disclosure herein.

The above-described aspects and further aspects, features and advantages of the disclosure herein can likewise be gathered from the examples of the embodiments, which are described below with reference to the attached drawings.

### BRIEF DESCRIPTION OF THE DRAWINGS

FIG. 1A-FIG. 1E depict a process for producing a sandwich component 1′ according to the disclosure herein.

FIG. 2 shows a material according to the disclosure herein, which comprises a first and a second cover layer composed of or comprising fiber-reinforced plastic as well as a core layer composed of or comprising foam or elastomer and also, embedded therein, wires composed of or comprising shape-memory metal.

### DETAILED DESCRIPTION

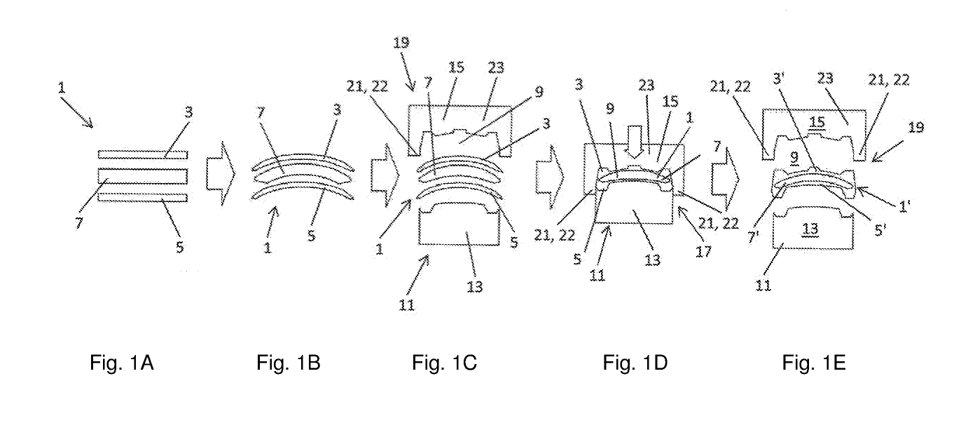

FIG. 1 depicts a process for producing a sandwich component 1′ according to the disclosure herein. The process is an impact extrusion process comprising the following steps.

As shown in FIG. 1A, what is first provided is semi-finished sandwich product 1 which comprises a first cover-layer semi-finished ply 3, a second cover-layer semi-finished ply 5, and a core-layer semi-finished ply 7 between the first and the second cover-layer semi-finished ply 3, 5. The first and the second cover-layer semi-finished ply 3, 5 are formed as semi-finished SMC plies and comprise a long-fiber-reinforced press compound with thermoset matrix, with carbon or glass fibers having an average fiber length of between 25 mm and 50 mm being embedded as random fibers in a thermoset reaction resin. The core-layer semi-finished ply 7 is formed from foam material, into which wires composed of or comprising shape-memory alloy are embedded. The wires composed of or comprising shape-memory alloy can be oriented substantially unidirectionally, form a 90° woven fabric or laid scrim.

Thereafter, as shown in FIG. 1B, the semi-finished sandwich product 1 is prepared for the press operation, wherein the semi-finished sandwich product 1 is pre-shaped and cut to size in order to thus be matched with the shape of the cavity 9 of a press device 11. This involves pre-heating the core-layer semi-finished ply 7 composed of or comprising foam with wires composed of or comprising shape-memory metal, with the result that its volume upon insertion into the cavity 9 occupies approx. 80% of the volume of the core layer 7′ of the finished sandwich component 1′. Thereafter, the prepared semi-finished sandwich product 1 is placed into the cavity 9 of the press device 11, as depicted in FIG. 1C. The press device 11 comprises a first mold part 13 and a second mold part 15 which can be moved relative to one another between a closed position 17, in which they enclose the cavity 9, and an open position 19, in which the cavity 9 is open to the environment. In the present exemplary embodiment, the press device 11 is designed as a positive mold, with the first mold part 13 being formed as the female mold and the second mold part 15 being formed as the male mold. The first mold part 13 is immobile and the second mold part 15 moves from the open position 19 into the closed position 17 in a vertical direction from above onto the first mold part 13. The first mold part 13 and the second mold part 15 are heatable in a controlled manner. The shape of the cavity 9 corresponds to the shape of the sandwich component 1′ to be produced.

As depicted in FIG. 1D, the second mold part 15 is now moved towards the first mold part 13, with the result that the press device 11 is brought into the closed position 17. In the closed position 17, the second mold part 15 is pressed with such a force onto the first mold part 13 that the semi-finished sandwich product 1 situated in the cavity 9 experiences a certain press pressure necessary for shaping and curing the semi-finished sandwich product 1. At the same time, the first and the second mold part 13, 15 is heated such that the semi-finished sandwich product 1 experiences a certain processing temperature, between 140° C. and 150° C. in the present case. In this way, the semi-finished sandwich product 1 is impact extruded, i.e. brought into the intended shape, namely the shape of the cavity 9, wherein the matrix of the cover-layer semi-finished plies 3, 5 is brought into a flow state and is then cured.

In order not to destroy the foam of the core-layer semi-finished ply 7 owing to the press pressure, the press device 11 comprises a spacer 21 which, in the closed position 17, defines the minimum distance between the first and the second mold part 13, 15 and thus sets the minimum dimensions of the cavity 9 and therefore the maximum press pressure. The spacer 21 is, depending on the geometry of the cavity 9 and on the materials of the cover-layer semi-finished plies 3, 5 and of the core-layer semi-finished ply 7, adjusted such that the press pressure in the closed position 17, when the spacer 21 limits the distance between the first and the second mold part 13, 15 to the minimum distance, is between a minimum processing pressure of the first and the second cover-layer semi-finished ply 3, 5 and a maximum permissible pressure limit for the core-layer semi-finished ply 7. In the present embodiment, the spacer 21 is designed as a stop element 22, which is provided on the second mold part 15 to the side of the cavity 9 and stops on the first mold part 13 upon a movement into the closed position 17 in order to thus set the minimum distance between the first and the second mold part 13, 15. Further provided is a control device 23 which controls the movement of the second mold part 15 onto the first mold part 13 into the closed position 17 or the force with which the second mold part 15 presses onto the first mold part 13 such that the pressure of the first and the second mold part 13, 15 on the semi-finished sandwich product 1 is only very slowly increased before the stopping of the stop element 22 and achievement of the press pressure.

As shown in FIG. 1E, after the sandwich component 1′ is cured to completion, the second mold part 15 is moved away from the first mold part 13 and brought into the open position 19, followed by removal of the finished sandwich component 1′ from the press device 11. The sandwich component 1′ comprises a core layer 7′ composed of or comprising foam with wires composed of or comprising shape-memory metal as well as a first and a second cover layer 3′, 5′ composed of or comprising fiber-reinforced plastic.

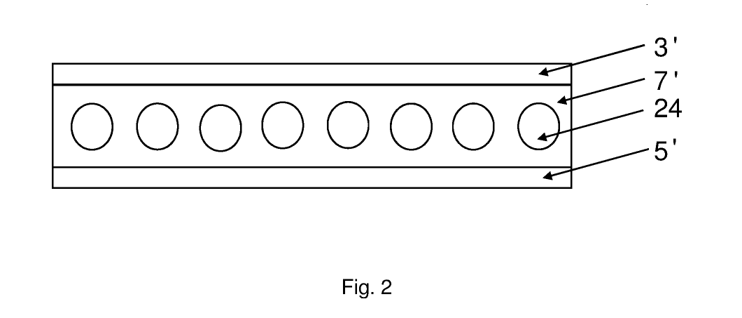

FIG. 2 shows a material according to the disclosure herein, which comprises a first and a second cover layer 3′, 5′ composed of or comprising fiber-reinforced plastic as well as a core layer 7′ composed of or comprising foam or elastomer and also, embedded therein, wires (24) composed of or comprising shape-memory metal.

While the disclosure herein has been illustrated and described in detail in the drawings and the preceding description, the intention is that such illustrations and descriptions are merely of an illustrative or exemplary nature and not of a limiting nature, and so the disclosure herein is not limited by the disclosed embodiments. Just the fact that certain features are mentioned in various dependent claims does not limit the subject matter of the disclosure herein. Combinations of the features can be advantageously used, too. The reference signs in the claims are not intended to limit the scope of the claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A sandwich component comprising at least two cover layers and one core layer containing wires comprising shape-memory metal.

2. The sandwich component according to claim 1, wherein the wires comprising shape-memory metal in the core layer are arranged substantially in parallel to one another.

3. The sandwich component according to claim 1, wherein the wires comprising shape-memory metal in the core layer are arranged in relation to one another substantially in a form of a woven fabric.

4. The sandwich component according to claim 1, wherein the wires comprising shape-memory metal in the core layer are heatable.

5. The sandwich component according to claim 1, wherein the cover layers comprises epoxy, vinyl ester, phenol or unsaturated polyester resin.

6. The sandwich component according to claim 1, comprising an intermediate layer comprising an elastomer.

7. The sandwich component according to claim 6, wherein the intermediate layer comprises EPDM, BR or EVA.

8. The sandwich component according to claim 6, wherein the intermediate layer comprises EPDM, BR and EVA.

9. The sandwich component according to claim 6, wherein the intermediate layer comprises elastomer in a form of calendered films.

10. The sandwich component according to claim 6, wherein the intermediate layer comprises elastomer in a form of a plurality of calendered films, between which the wires comprising shape-memory metal are disposed.

11. The sandwich component according to claim 1, wherein the wires comprising shape-memory metal are electrically heatable.

12. The sandwich component according to claim 1, wherein the wires comprising shape-memory metal are electrically heatable by application of an electric voltage to the wires themselves.

13. The sandwich component according to claim 1, wherein the wires comprising shape-memory metal are heatable by induction.

14. The sandwich component according to claim 1, wherein the wires comprising shape-memory metal are temperature-adjustable by a cooling device.

15. A wing tip of an aircraft that comprises a sandwich component according to claim 1.

16. An aileron, elevator or rudder of an aircraft that comprises a sandwich component according to claim 1.

17. An air channel for an aircraft that comprises a sandwich component according to claim 1.

18. A seat, recliner or bed for an aircraft that comprises a sandwich component according to claim 1.

19. A wing of an aircraft that comprises a sandwich component according to claim 1.

20. An air flap or ventilation nozzle of an aircraft that comprises a sandwich component according to claim 1.

21. A horizontal stabilizer or vertical stabilizer of an aircraft that comprises a sandwich component according to claim 1.

22. A sandwich component comprising at least two cover layers and one core layer containing wires comprising shape-memory metal, obtainable by a process comprising:
providing a press device having a first mold part and a second mold part which can be moved relative to one another between a closed position, in which they enclose a cavity, and an open position, in which the cavity is open to an environment, wherein the first mold part and/or the second mold part are heatable;
providing a semi-finished sandwich product having a first cover-layer semi-finished ply comprising a long-fiber-reinforced press compound with thermoset matrix, a second cover-layer semi-finished ply comprising a long-fiber-reinforced press compound with thermoset matrix, and, between them, a core-layer semi-finished ply;
in the open position of the press device, inserting the semi-finished sandwich product into the cavity;
moving the first and the second mold part relative to one another into the closed position; and
pressing together the first and the second mold part, wherein the semi-finished sandwich product experiences a certain press pressure, and heating the first and/or the second mold part, wherein the semi-finished sandwich product experiences a certain processing temperature, wherein the press device comprises a spacer, which, in the closed position, defines a minimum distance between the first and the second mold part and thus sets the minimum dimensions of the cavity, and wherein the spacer is adjusted such that the press pressure in the closed position is between a minimum processing pressure of the first and/or the second cover-layer semi-finished ply and a maximum permissible pressure limit for the core-layer semi-finished ply.
